(19) United States
(12) Patent Application Publication
(10) Pub. No.: US 2004/0115429 A1
(43) Pub. Date: Jun. 17, 2004

(54) Pulverulent formaldehyde-free binder composition and use thereof for thermal curing of substrates

(75) Inventors: Kathrin Michl, Ludwigshafen (DE); Matthias Gerst, Neustadt (DE); Matthias Laubender, Schifferstadt (DE); Iris Rau, Buerstadt (DE); Bernd Reck, Gruenstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/724,692

(22) Filed: Dec. 2, 2003

(30) Foreign Application Priority Data
Dec. 13, 2002 (DE) 10258441.9

(51) Int. Cl. B32B 25/00

(52) U.S. Cl. 428/357; 428/402.22; 428/473.5; 428/383; 428/364

(57) ABSTRACT

The present invention relates to a pulverulent formaldehyde-free binder composition containing

a) a pulverulent copolymer polymerized from maleic anhydride and at least one α-olefin, optionally styrene; and also

b) at least one pulverulent crosslinker; and also

c) optionally further additive materials.

The present invention further relates to a process for binding fibrous and/or granular substrates by means of the binder composition of the present invention and also to the shaped articles obtainable therefrom.

The present invention relates to a pulverulent formaldehyde-free binder composition especially for fibrous and/or granular substrates.

Similarly, the present invention relates to a process for binding fibrous and/or granular substrates by means of a pulverulent formaldehyde-free composition and to the products obtainable thereby. The present invention further relates to the use of a pulverulent formaldehyde-free binder composition as a binder for fibrous and/or granular substrates.

Binders are products which bind similar or different materials together. Binders are classified in terms of their structure as organic or inorganic or as natural or synthetic binders. Materials are bound together by physical drying (aqueous or organic solutions, polymer dispersions), by solidifying or a substantial increase in viscosity (melting), by chemical reaction (polymer-based reactive system; drying oils with added siccatives; carbonatization, as with lime mortar for example) or by hydration (hydraulic binders, cement). Numerous binders are known from the prior art.

DE-A 199 59 415 relates to a process for prebinding fiber materials preferably composed of glass, polyamide and carbon fibers by means of a pulverulent binder composition which consists of a pulverulent interpolymer and a pulverulent crosslinker. The pulverulent interpolymer is prepared by emulsion polymerization of one or more monomers selected from the group consisting of vinyl esters, acrylic esters, methacrylic esters, vinylaromatics and vinyl chloride. The pulverulent binder composition is mixed with the substrates to be bound and heated, and the prebinding ensues. A disadvantage of this prior art binder composition is that it confers on the bound substrate a fairly low mechanical strength and dimensional stability especially under humid conditions. In addition, the binder has only low tack under anhydrous application conditions. For a definition of tack, see the reference A. Zosel, E. Wistuba, J. Adhesion SCI Technol., Vol. 11, 1997, “The Effect of Bond Formation on the Tack of Polymers”.

EP-A 0 687 317 relates to the use of crosslinkable redispersible powders which are based on vinyl ester copolymers or (meth)acrylic ester copolymers as a binder for dry binding of fiber materials. The crosslinker used is an ethylenically unsaturated, crosslinking comonomer. The disadvantages with these binder compositions are the low mechanical strength and dimensional stability especially under humid conditions and also the insufficient tack of the binder composition.

It is an object of the present invention to provide pulverulent formaldehyde-free binders for substrates, for example shaped articles. These binders shall be preferentially suitable for fibrous and/or granular substrates, for example rice cotton, natural fibers, etc. More particularly, the binders shall confer on the bound product a high mechanical strength and dimensional stability even under humid conditions. At the same time, the binder shall possess sufficient tack under anhydrous application conditions. Furthermore, the pulverulent binder shall possess high stability in storage.

It is a further object of the present invention to provide a process for binding fibrous and/or granular substrates whereby the bound product acquires a high mechanical strength and dimensional stability even under humid conditions. It is a further object of the present invention to provide shaped articles which are formed by binding fibrous and/or granular substrates and which possess high mechanical strength and dimensional stability even under humid conditions.

We have found that these objects are achieved by providing a pulverulent formaldehyde-free binder composition, especially for fibrous and/or granular substrates, containing

a) a pulverulent copolymer polymerized from maleic anhydride and at least one α-olefin as component A; and also

b) at least one pulverulent crosslinker which has two or more reactive groups capable of reacting with the carbonyl groups of maleic anhydride, as component B; and also

c) optionally further additive materials.

A further embodiment of the pulverulent formaldehyde-free binder composition of the present invention preferably contains

a) a pulverulent copolymer formed from 25 mol % to 50 mol %, based on the copolymer, of maleic anhydride, at least one α-olefin and/or styrene as component A′; and

b) at least one pulverulent crosslinker which has two or more reactive groups capable of reacting with the carbonyl groups of maleic anhydride, as component B; and also

c) optionally further additive materials.

It is preferable in the case of the second embodiment for the copolymer (component A′) to be polymerized from maleic anhydride and styrene.

The pulverulent formaldehyde-free binder compositions of the present invention are especially useful for fibrous and/or granular substrates. For the purposes of the present invention, a fiber is any elongate aggregate. Examples of useful fibrous substrates for the present invention are mineral fibers, rockwool fibers, glass fibers, wood fibers, hemp fibers, sisal fibers, jute fibers, flax fibers, textile fibers, wool fibers, cotton fibers, cellulose fibers and synthetic fibers (eg polyester, nylon). Examples of useful granular substrates for the present invention are wood chips, cork granules, sand (core sand binding for casting molds) and aluminum oxides (abrasive materials).

The binders of the present invention are pulverulent. So the products, especially shaped articles, resulting from the binding of the especially fibrous and/or granular substrates preferably no longer have to be dried, as is the case with the aqueous binder compositions of the prior art. In addition, the binder compositions of the present invention do not contain formaldehyde, so that no formaldehyde emissions occur in the course of the production of the bound products nor in the course of their later use.

Component A and Component A′

The maleic anhydride fraction in the component A copolymer is generally in the range from 25 mol % to 50 mol %, preferably in the range from 40 mol % to 50 mol % and more preferably 50 mol % based on the copolymer. The α-olefin fraction in the component A copolymer is generally in the range from 50 mol % to 75 mol %, preferably in the range from 50 mol % to 60 mol % and more preferably 50 mol %, based on the copolymer.

The maleic anhydride fraction in the component A′ copolymer is generally in the range from 25 mol % to 50 mol %, preferably in the range from 40 mol % to 50 mol % and more preferably 50 mol %, based on the copolymer. The level of α-olefin and the styrene on the one hand or the level of α-olefin or styrene on the other (component A′) is generally in the range from 50 to 75 mol % and preferably in the range from 50 to 60 mol % and more preferably 50 mol %, based on the copolymer.

Component A of the binder composition according to the present invention comprises at least one α-olefin. But component A of the binder composition according to the present invention may also comprise a plurality of different α-olefins. Useful α-olefins for the purposes of the present invention are generally the C₄- to C₃₂-α-olefins, preferably C₄- to C₁₆-α-olefins, more preferably C₄- to C₈-α-olefins and most preferably isobutene and diisobutene. The same holds for the α-olefin in component A′.

The fraction of copolymer (component A or component A′) in the binder composition of the present invention is generally in the range from 5% by weight to 95% by weight, preferably in the range from 40% by weight to 90% by weight and more preferably in the range from 40 to 60% by weight, each percentage being based on the binder composition.

The softening point of the component A copolymer of the binder composition according to the present invention is generally between 40° C. and 250° C., preferably between 70° C. and 220° C. and more preferably between 90° C. and 200° C.

The number average molecular weight (Mₙ) of the copolymer of component A in the binder composition according to the present invention is generally between 200 g/mol and 50 000 g/mol, preferably between 500 g/mol and 20 000 g/mol and more preferably between 3000 g/mol and 10 000 g/mol. Mn is determined by gel permeation chromatography.

Component B

Useful crosslinkers (component B) for the binder composition of the present invention are pulverulent compounds which contain two or more or plural reactive groups capable of reacting with the carbonyl groups of maleic anhydride. Suitable for this purpose are for example polyfunctional alcohols, polyfunctional amines, molecules which contain hydroxyl and/or amino groups, thiols, hydroxyl-terminated polymers, epoxides, isocyanates, organohalogen compounds, aziridines, carbodiimides, oxazolines, aminosilanes and hydroxyalkylamines.

The crosslinker used according to the present invention is preferably selected from the group consisting of trimethylolpropane, 1,6-hexanediol, pentaerythritol, neopentylglycol, L-lysine, sorbitol and polyvinyl alcohol.

The fraction of crosslinker component B in the binder composition of the present invention is generally in the range from 5% by weight to 95% by weight, preferably in the range from 10% by weight to 60% by weight and more preferably in the range from 40 to 60% by weight, each percentage being based on the binder composition.

The melting or softening point of the crosslinker component B is generally in the range between 40° C. and 270° C., preferably between 70° C. and 220° C. and more preferably between 90° C. and 200° C.

The pulverulent binder composition may optionally additionally contain at least one crosslinking catalyst. The catalyst used is preferably an acidic catalyst or a Lewis acid. The catalyst used according to the present invention is preferably paratoluenesulfonic acid. Further crosslinking catalysts according to the present invention are catalysts based on organic compounds which contain quaternary groups of elements of the 5th main group of the periodic table of the elements. Preference is given to pulverulent catalysts which are derived from triphenylphosphonium halides or quaternary ammonium compounds. Examples thereof are methyltriphenylphosphonium bromide, ethyltriphenylphosphonium bromide, propyltriphenylphosphonium bromide, butyltriphenylphosphonium bromide and the corresponding iodides and chlorides. Also suitable are triphenylphosphonium halides having a substituted alkyl radical such as 2-carboxyethyltriphenylphosphonium bromide, 3-bromopropyltriphenyl-phosphonium bromide or formylmethyltriphenylphosphonium bromide. Suitable quaternary ammonium compounds are tetrabutylammonium salts, benzyltrimethyl-ammonium salts, methyltributylammonium salts. When the binder composition of the present invention contains a crosslinking catalyst, it is generally present in amounts from 0 to 10% by weight, preferably present in amounts from 0.1 to 5% by weight and more preferably present in amounts from 0.2 to 3% by weight, based on the binder composition of the present invention.

Component C

The binder composition of the present invention may optionally additionally contain further additive materials as component C. These further additive materials include in particular antiblocking agents, antifoaming agents, emulsifiers, dyes, flame retardants, fillers, fungicides, coupling agents, hydrophobicizers, insecticides, catalysts, pigments, Theological assistants, thickeners, filming agents, plasticizers and cocrosslinkers. Component C may be present in an amount of generally 0 to 30% by weight, preferably from 2 to 20% by weight and more preferably from 5 to 10% by weight, based on the binder composition of the present invention.

Binder Composition

In the binder composition of the present invention, the difference between the softening point of the copolymer component A and the softening point of the crosslinker component B is generally less than 250° C., preferably less than 200° C. and more preferably less than 180° C.

In a preferred embodiment of the binder composition according to the present invention, the storage modulus G′ initially decreases at least once to a value ≦10⁸ Pa, preferably ≦10⁷ Pa, in particular ≦10⁶ Pa, and then rises again, on heating from 50° C. to 300° C., preferably from 50° C. to 250° C. and more preferably 80° C. to 250° C. The storage modulus G′ is determined by means of rheological investigations which are described in A. Franck, Kunststoff Kompendium, Vogel Buchverlag, 4th edition, 1996, pages 253 and following.

The present invention further provides a process for binding fibrous and/or granular substrates. The process for binding fibrous and/or granular substrates comprises a pulverulent formaldehyde-free binder composition being mixed with fibrous and/or granular substrates. The substrates are then bound by the binder composition of the present invention preferably by heating in the presence or absence of a crosslinking catalyst. The advantage with this process is in particular that no solvent, such as water for example, is needed for the binding of substrates, so that subsequent drying of the bound substrates is preferably not necessary.

With regard to the fibrous and/or granular substrates which can be bound by the process of the present invention, reference is made to the above exposition regarding the binder composition of the present invention.

The crosslinking catalyst is preferably an acidic catalyst or a Lewis acid. The catalyst used according to the present invention is preferably paratoluenesulfonic acid. Further crosslinking catalysts according to the present invention are catalysts based on organic compounds which contain quaternary groups of elements of the 5th main group of the periodic table of the elements. Preference is given to pulverulent catalysts which are derived from triphenylphosphonium halides or quaternary ammonium compounds. Examples thereof are methyltriphenyl-phosphonium bromide, ethyltriphenylphosphonium bromide, propyltriphenyl-phosphonium bromide, butyltriphenylphosphonium bromide and the corresponding iodides and chlorides. Also suitable are triphenylphosphonium halides having a substituted alkyl radical such as 2-carboxyethyltriphenylphosphonium bromide, 3-bromopropyltriphenylphosphonium bromide or formylmethyltriphenyl-phosphonium bromide. Suitable quaternary ammonium compounds are tetrabutyl-ammonium salts, benzyltrimethylammonium salts, methyltributylammonium salts.

The fibrous and/or granular substrates, which may also have three-dimensional shapes, are laid out prior to consolidation. The processes for the laying out are known and primarily dependent on the use to which the consolidated fibrous and/or granular substrate is to be put. The fibrous and/or granular substrates can be laid out by means of a mixture and additionally also using further techniques such as airlaid, wetlaid, direct spinning or carding apparatus. Optionally, the substrates laid out in the form of sheetlike structures can be additionally mechanically consolidated, for example by crosslaying, needling or hydroentangling, prior to binder consolidation.

In the process of the present invention, the formaldehyde-free pulverulent binder composition is conventionally sprinkled on to the optionally mechanically preconsolidated fibrous and/or granular substrate, sprinkled in (for example through card waddings), shaken in or directly mixed with the fiber.

In the process of the present invention, binding time and temperature have to be adapted to the system of substrate and binder. For instance, the process according to the present invention can be carried out for a certain system for example for 1 h at 230° C. or else for 24 h at 120° C. It is thus envisioned according to the present invention that binding time and binding temperature can be varied in mutual dependence.

The amount of binder composition according to the present invention which is used in the process according to the present invention is generally in the range from 5 to 70% by weight, preferably in the range from 10 to 60% by weight and more preferably in the range from 15 to 50% by weight, each percentage being based on the substrate.

The present invention also provides the products which are preparable by the process according to the present invention and consist of fibrous and/or granular substrates, especially shaped articles. These shaped articles exhibit high mechanical strength and dimensional stability especially under humid conditions.

The present invention further provides for the uses or applications of the formaldehyde-free pulverulent binder composition according to the present invention especially for fibrous and/or granular substrates.

With regard to the fibrous and/or granular substrates, reference is made to the above exposition.

The present invention exhibits a number of advantages over the prior art:

The binder composition according to the present invention is especially suitable for fibrous and/or granular substrates. The binder composition according to the present invention is formaldehyde-free, so that neither the binder composition itself nor the bound products produced with it, especially shaped articles, give off formaldehyde under the action of moisture and/or heat. The binder compositions according to the present invention confer high mechanical strength and dimensional stability on the bound product. This holds under humid conditions in particular. The binder composition according to the present invention exhibits excellent tack under anhydrous application conditions.

Further refinements, modifications and variations and also advantages of the present invention will be readily apparent to one skilled in the art on reading the description and are achievable for one skilled in the art without leaving the scope of the present invention.

The present invention is illustrated by the nonlimiting examples hereinbelow.

### EXAMPLES

General

Dynamic Mechanical Measurements:

The storage modulus G′ was measured using an ARES deformation-controlled modular rheometer system from Rheometrics Incorporated with a 2K FRTN1 force transducer. Measuring arrangement: parallel plate geometry, plate diameter: 25 mm, sample thickness about 1 mm. The storage modulus G′ was measured as a function of the temperature using a measuring frequency of 1 Hz and a heating rate of 1° C./minute. The amount of binder composition according to the present invention that is used in the process according to the present invention is generally in the range from 5 to 70% by weight, preferably in the range from 5 to 60% by weight and more preferably in the range from 5 to 50% by weight, based on the substrate.

Gel Permeation Chromatography:

A combination of 4 separating columns (each 7.8 mm in internal diameter, 30 cm in length and 35° C. in column temperature) employing the following separating materials was used:

| | | Polyethylene oxide |
|---|---|---|
| Column No. | Separating material | molecular weight cutoff |
| 1 | TSK G5000 PW x1 | 4000-1000000 |
| 2 | Waters Ultrahydrogel 1000 | 1000000 |
| 3 | Waters Ultrahydrogel 500 | 400000 |
| 4 | Waters Ultrahydrogel 500 | 400000 |

The mobile phase used was 0.008 M TRIS buffer (tris(hydroxymethyl)amino-methane, Merck, Darmstadt) at pH 7 in distilled water in the presence of 0.15 mol/L NaCl and 0.01 mol/L NaN₃.

The amount of sample solution injected was 400 μL in each case.

The flow rate was 0.5 mL/min. The number of plates in the separating column combination at this flow rate was 37 000.

The detector used was an ERC 7510 differential refractometer from ERMA.

The evaluation was discontinued after a flow volume of 39.6 mL (M(Na-PAA) about 642) (integration limit). The chromatograms obtained were integrated along the lines of DIN 55672-1 to an accuracy of ±3%.

### COMPARATIVE EXAMPLE

Vinnex®LL572 from Wacker Polymer Systems GmbH was used as a comparative binder. Vinnex® LL572 is a self-crosslinking binder powder based on polyvinyl acetate that is recommended for binding glass, natural and polyester fibers. Vinnex® LL572 was presented as a binder for reclaimed cotton at Index 99 (reference: Index 99, 1999, Kohlhammer, “Dry Emulsion Binders”).

### Inventive Example 1

A binder composition was prepared from 50% by weight of maleic anhydride-styrene copolymer (molar ratio=1:3) and 50% by weight of pentaerythritol crosslinker.

### Inventive Example 2

A binder composition was prepared from 50% by weight of maleic anhydride-isobutene copolymer (molar ratio=1:1) and 50% by weight of trimethylolpropane crosslinker.

### Inventive Example 3

A binder composition was prepared from 50% by weight of maleic anhydride-diisobutene copolymer (molar ratio=1:1) and 50% by weight of Primid XL 552 (bisdiethanolamide of adipic acid) crosslinker.

All four binder compositions were rated on a scale from 1 to 6, where 1=very good and 6=unsatisfactory, with regard to their strength and their deflection under different environmental conditions and different durations. Reclaimed cotton was the substrate bound in all four examples.

| Parameter | Comp. Ex. 1 | Inv. Ex. 1 | Inv. Ex. 2 | Inv. Ex. 3 |
|---|---|---|---|---|
| Molding temperature [° C.] | 200 | 200 | 200 | 200 |
| Molding time [sec] | 40/10/130* | 40/10/130* | 40/10/130* | 40/10/130* |
| Molding pressure [bar] | 50/0/200^{#} | 50/0/200^{#} | 50/0/200^{#} | 50/0/200^{#} |
| Plate thickness [mm] | 5.4 | 5.5 | 5.4 | 5.6 |
| Strength rating after molding on a scale | 6 | 1- | 1- | 1- |
| from 1 to 6 | | | | |
| Strength rating after 3 d, 120° C. on a | 6 | 1- | 1- | 1- |
| scale from 1 to 6 | | | | |
| Strength rating after 3 d, 50° C., 95% | 6 | 1- | 3 | 2 |
| relative humidity on a scale from 1 to 6 | | | | |
| Rating of deflection, 1 d, 120° C., [mm] | 6** | 1.5 | 2 | 2 |
| Rating of deflection, 1 d, 50° C., 95% | 6** | 2 | 5.5 | 5.5 |
| relative humidity, [mm] | | | | |

*Program: pre-pressing 40 sec/press open 10 sec/pressing 130 sec
^{#}Program: pre-pressing at 50 bar/press open at 0 bar/pressing at 200 bar
**the material is extremely weak

As is evident from the table, the binder compositions of the present invention exhibit good to very good strength and deflection values, whereas there is no binding with the composition of the comparative example.

We claim:

1. A pulverulent formaldehyde-free binder composition, especially for fibrous and/or granular substrates, containing
a) a pulverulent copolymer polymerized from maleic anhydride and at least one α-olefin as component A; and also
b) at least one pulverulent crosslinker which has two or more reactive groups capable of reacting with the carbonyl groups of maleic anhydride, as component B; and also
c) optionally further additive materials.

2. A binder composition as claimed in claim 1, wherein the maleic anhydride fraction in the copolymer is up to 50% by weight, based on the copolymer.

3. A binder composition as claimed in claim 1, wherein the copolymer fraction in the binder composition is in the range from 5% by weight to 95% by weight, preferably in the range from 40% by weight to 90% by weight and especially in the range from 40% by weight to 60% by weight, each percentage being based on the binder composition, and/or the crosslinker fraction in the binder composition is in the range from 5 to 95% by weight, especially in the range from 10 to 60% by weight and preferably in the range from 40 to 60% by weight, each percentage being based on the binder composition.

4. A binder composition as claimed in claim 1, wherein the α-olefin is a C₄- to C₃₂-α-olefins, preferably C₄- to C₆-α-olefins, more preferably C₄- to C₈-α-olefins and most preferably isobutene and diisobutene.

5. A binder composition as claimed in claim 1, wherein the crosslinker is selected from the group consisting of polyfunctional alcohols, polyfunctional amines, molecules which contain hydroxyl and/or amino groups, thiols, hydroxyl-terminated polymers, epoxides, isocyanates, organohalogen compounds, aziridines, carbodiimides, oxazolines, aminosilanes and hydroxylalkylamines.

6. A binder composition as claimed in claim 1, wherein the difference between the softening point of the copolymer and the melting or softening point of the crosslinker is generally less than 250° C., preferably less than 200° C. and more preferably less than 180° C.

7. A binder composition as claimed in claim 1, wherein the storage modulus G′ initially decreases at least once to a value ≦10⁸ Pa, preferably ≦10⁷ Pa and more preferably ≦10⁶ Pa, and then rises again, on heating from 50° C. to 300° C., preferably from 50° C. to 250° C. and more preferably 80° C. to 250° C.

8. A pulverulent formaldehyde-free binder composition, especially for fibrous and/or granular substrates, containing
a) a pulverulent copolymer formed from 25 mol % to 50 mol %, based on the copolymer, of maleic anhydride, at least one α-olefin and/or styrene as component A′; and
b) at least one pulverulent crosslinker which has two or more reactive groups capable of reacting with the carbonyl groups of maleic anhydride, as component B; and also
c) optionally further additive materials.

9. A binder composition as claimed in claim 8, wherein the copolymer fraction in the binder composition is in the range from 5% by weight to 95% by weight, preferably in the range from 40% by weight to 90% by weight and especially in the range from 40% by weight to 60% by weight, each percentage being based on the binder composition, and/or the crosslinker fraction in the binder composition is in the range from 5 to 95% by weight, especially in the range from 10 to 60% by weight and preferably in the range from 40 to 60% by weight, each percentage being based on the binder composition.

10. A binder composition as claimed in claim 8, wherein the α-olefin is a C₄- to C₃₂-α-olefins, preferably C₄- to C₆-α-olefins, more preferably C₄- to C₈-α-olefins and most preferably isobutene and diisobutene.

11. A binder composition as claimed in claim 8, wherein the crosslinker is selected from the group consisting of polyfunctional alcohols, polyfunctional amines, molecules which contain hydroxyl and/or amino groups, thiols, hydroxyl-terminated polymers, epoxides, isocyanates, organohalogen compounds, aziridines, carbodiimides, oxazolines, aminosilanes and hydroxylalkylamines.

12. A binder composition as claimed in claim 8, wherein the difference between the softening point of the copolymer and the melting or softening point of the crosslinker is generally less than 250° C., preferably less than 200° C. and more preferably less than 180° C.

13. A binder composition as claimed in claim 8, wherein the storage modulus G′ initially decreases at least once to a value ≦10⁸ Pa, preferably ≦10⁷ Pa and more preferably ≦10⁶ Pa, and then rises again, on heating from 50° C. to 300° C., preferably from 50° C. to 250° C. and more preferably 80° C. to 250° C.

14. A process for binding fibrous and/or granular substrates, which comprises a pulverulent formaldehyde-free binder composition as claimed in claim 1 being mixed with fibrous and/or granular substrates and binding the latter preferably by heating in the presence or absence of at least one catalyst.

15. A process as claimed in claim 14, wherein the fibrous and/or granular substrate is selected from the group consisting of rockwool fibers, mineral fibers, glass fibers, wood fibers, hemp fibers, sisal fibers, jute fibers, flax fibers, textile fibers, wool fibers, cotton fibers, cellulose fibers and synthetic fibers, especially polyester and nylon, wood chips, cork granules, sand, especially core sand for casting molds, aluminum oxides, especially abrasive materials.

16. A process for binding fibrous and/or granular substrates, which comprises a pulverulent formaldehyde-free binder composition as claimed in claim 8 being mixed with fibrous and/or granular substrates and binding the latter preferably by heating in the presence or absence of at least one catalyst.

17. A process as claimed in claim 16, wherein the fibrous and/or granular substrate is selected from the group consisting of rockwool fibers, mineral fibers, glass fibers, wood fibers, hemp fibers, sisal fibers, jute fibers, flax fibers, textile fibers, wool fibers, cotton fibers, cellulose fibers and synthetic fibers, especially polyester and nylon, wood chips, cork granules, sand, especially core sand for casting molds, aluminum oxides, especially abrasive materials.

18. Products, especially shaped articles, obtainable by the process of claim 14.

19. Products, especially shaped articles, obtainable by the process of claim 16.
